(19) United States
(12) Patent Application Publication
(10) Pub. No.: US 2023/0289878 A1
(43) Pub. Date: Sep. 14, 2023

(54) METHODS AND SYSTEMS FOR TRANSPORTING A USER FROM A FIRST VIRTUAL ENVIRONMENT TO A SECOND VIRTUAL ENVIRONMENT IN A PLURALITY OF VIRTUAL ENVIRONMENTS WHILE MAINTAINING ACCESS TO A DIGITAL WALLET OF THE USER

(71) Applicant: Go MetaRail Corp., Houston, TX (US)

(72) Inventor: Christian Robert Augustine, Porter, TX (US)

(21) Appl. No.: 18/117,666

(22) Filed: Mar. 6, 2023

Related U.S. Application Data
(60) Provisional application No. 63/431,976, filed on Dec. 12, 2022.
(60) Provisional application No. 63/398,522, filed on Aug. 16, 2022.
(60) Provisional application No. 63/317,884, filed on Mar. 8, 2022.

(51) Int. Cl. G06Q 40/04; G06Q 20/06; G06Q 20/36

(52) U.S. Cl. CPC G06Q 40/04; G06Q 20/065; G06Q 20/36

(57) ABSTRACT

A method for transferring control over a session from a first virtual environment to a second virtual environment includes receiving, by a first virtual environment, a request for a transfer to a second virtual environment. The method includes transmitting, by the first virtual environment, to a first event handler, the request. The method includes retrieving, by the first event handler, an address for the second virtual environment and an identification of a location within the second virtual environment at which to instantiate at least one digital resource associated with the user. The method includes establishing, by the first event handler, a connection to a second computing device executing a second event handler. The method includes transmitting, by the first event handler, to the second event handler, via the connection, an identification of the user and an instruction to establish a session between the user and the second virtual environment.

### CROSS REFERENCE TO RELATED APPLICATIONS

This application claims priority from U.S. Provisional Pat. Application Serial No. 63/317,884, filed on Mar. 8, 2022, entitled “Metaverse Transport System That is configured To Transport Users from One Metaverse Platform to Another,” and from U.S. Provisional Pat. Application Serial No. 63/398,522, filed on Aug. 16, 2022, entitled “Travel and Wallet Services between Virtual Worlds or Metaverse Platforms,” and from U.S. Provisional Pat. Application Serial No. 63/431,976, filed on Dec. 12, 2022, entitled “Metaverse Transport System That is configured To Transport Users from One Metaverse Platform to Another,” each of which is hereby incorporated by reference.

### BACKGROUND

Embodiments of the methods and systems described in this specification relate generally to software systems, and more particularly, to a metaverse transport system that is configured to transport users from one metaverse platform to another.

Conventional virtual worlds and metaverse platforms do not typically provide functionality allowing users to move from one platform to another without first leaving the metaverse. Conventional methods for navigating within one virtual environment or accessing digital assets within one virtual environment fail to provide functionality allowing a user to seamlessly continue an interactive experience after exiting a first virtual environment and initiating a session with a second virtual environment.

Furthermore, virtual worlds and metaverse platforms are typically launched from an app store, web browser, or other software platform that is not part of the metaverse. Previously, users would need to return to these places to launch other virtual world or metaverse platforms. This is an immersion-breaking experience for the user. Therefore, what is needed is a way to connect to each virtual world’s platform and/or each metaverse platform and allow those platforms to be launched directly, maintaining immersion for the user and increasing their enjoyment of the experience.

### BRIEF SUMMARY

A method for transferring control over at least one session associated with a user from a first virtual environment in a plurality of virtual environments to a second virtual environment in the plurality of virtual environments includes receiving, by a first virtual environment executing on a first computing device, from a user, a request for a transfer to a second virtual environment, wherein the first virtual environment is associated with a first entity, and wherein the second virtual environment is associated with a second entity. The method includes transmitting, by the first virtual environment to a first event handler executing on the first computing device, the request. The method includes retrieving, by the first event handler, an address for the second virtual environment and an identification of a location within the second virtual environment at which to instantiate at least one digital resource associated with the user. The method includes establishing, by the first event handler, an Application Programming Interface (API) connection to a second computing device executing a second event handler. The method includes transmitting, by the first event handler, to the second event handler, via the API connection, (i) an identification of the user and (ii) an instruction to establish a session between the user and the second virtual environment.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a system for transferring control over at least one session associated with a user from a first virtual environment in a plurality of virtual environments to a second virtual environment in the plurality of virtual environments;

FIG. 1B is a block diagram depicting an embodiment of a user interface in a system for transferring control over at least one session associated with a user from a first virtual environment in a plurality of virtual environments to a second virtual environment in the plurality of virtual environments;

FIG. 1C is a block diagram depicting an embodiment of a user interface in a system for transferring control over at least one session associated with a user from a first virtual environment in a plurality of virtual environments to a second virtual environment in the plurality of virtual environments;

FIG. 1D is a block diagram depicting an embodiment of a user interface in a system for transferring control over at least one session associated with a user from a first virtual environment in a plurality of virtual environments to a second virtual environment in the plurality of virtual environments;

FIG. 1E is a block diagram depicting an embodiment of a user interface in a system for transferring control over at least one session associated with a user from a first virtual environment in a plurality of virtual environments to a second virtual environment in the plurality of virtual environments;

FIG. 1F is a flow diagram depicting an embodiment of a method for establishing a connection to a first virtual environment;

FIG. 2A is a flow diagram depicting an embodiment of a method for transferring control over at least one session associated with a user from a first virtual environment in a plurality of virtual environments to a second virtual environment in the plurality of virtual environments;

FIG. 2B is a flow diagram depicting an embodiment of a method for transferring control over at least one session associated with a user from a first virtual environment in a plurality of virtual environments to a second virtual environment in the plurality of virtual environments;

FIG. 3A is a flow diagram depicting an embodiment of a method for identifying and exchanging token types for use of assets in a digital wallet in a plurality of virtual environments;

FIG. 3B is a flow chart depicting one embodiment of a method for converting cryptocurrency for use in a virtual environment;

FIG. 4 is a flow diagram depicting an embodiment of a method for identifying and exchanging token types for use of assets in a digital wallet in a plurality of virtual environments;

FIG. 5A is a flow diagram depicting an embodiment of a method for transferring control over at least one session associated with a user from a first virtual environment in a plurality of virtual environments to a second virtual environment in the plurality of virtual environments and for identifying and exchanging token types for use of assets in a digital wallet in a plurality of virtual environments;

FIG. 5B is a flow diagram depicting an embodiment of a method for transferring control over at least one session associated with a user from a first virtual environment in a plurality of virtual environments to a second virtual environment in the plurality of virtual environments and for identifying and exchanging token types for use of assets in a digital wallet in a plurality of virtual environments; and

FIGS. 6A-6C are block diagrams depicting embodiments of computers useful in connection with the methods and systems described herein.

### DETAILED DESCRIPTION

Methods and systems described herein provide functionality for configuring and executing a metaverse transport system to allow users to “travel” from one metaverse platform into another, or from one place in a metaverse platform to another place within the same metaverse platform. In some embodiments, the metaverse transport system is implemented in software which transports users from one metaverse platform to another. The software-implemented metaverse transport system may be configured to transport users from one metaverse platform into another, providing a connection to each available virtual world and metaverse platform, allowing the platforms to be launched directly, maintaining immersion for the user and increasing their enjoyment of the experience.

In the following detailed description of the invention, numerous details, examples, and embodiments of the invention are described. However, it will be clear and apparent to one skilled in the art that the invention is not limited to the embodiments set forth and that the invention can be adapted for any of several applications.

As used herein, the terms “virtual world”, “virtual environment,” “metaverse,” “metaverse platform”, and “virtual worlds and metaverse platforms,” are interchangeable. As will be understood by those of ordinary skill in the art, a virtual environment provides one or more user interfaces that provide the users with an impression of “presence”, that is, an impression that a digital representation (or “avatar”) of the user is in the virtual environment and that, by extension, the user herself is physically located within the environment. The user is represented in virtual space by a virtual user representation, which may be referred to as an avatar. The virtual user representation may be a collection of digital assets - for example, a digital image representing the user may form a base image and the user may choose to add layers on top of that base image, such as hair, clothing, accessories, and any other type of digital image adding to a representation of the user in that virtual environment. The user may use hardware and software that enhance the impression of presence - for example by utilizing augmented reality or virtual reality hardware that modify what the user actually sees in the physical world or by utilizing computing or gaming devices that provide sensory feedback to the user when the user interacts with user interface elements displayed in the user interfaces of the virtual environment.

As stated above, conventional functionality lacks the ability for users to move from one virtual environment to another without leaving the first virtual environment. Virtual worlds and metaverse platforms are launched from an app store, web browser, or other software platform, which are not part of the metaverse experience. Previously, users would need to leave a first virtual environment, identify and execute the app store or web browser or software platform required to launch a second virtual environment, and then complete a log-in process before accessing the second virtual environment. This may be a jarring and immersion- breaking experience for the user and may discourage users from attempting to interact with one or more virtual environments. By contrast, the methods and systems described herein include functionality configured to transport users from one metaverse platform directly into another virtual environment, allowing users to be launched directly, maintaining immersion for the users.

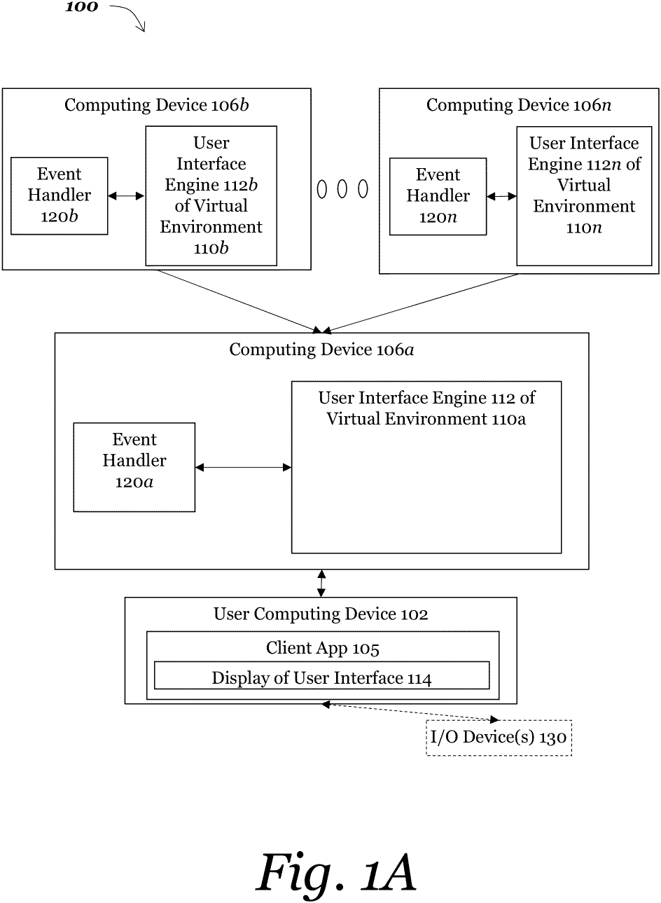

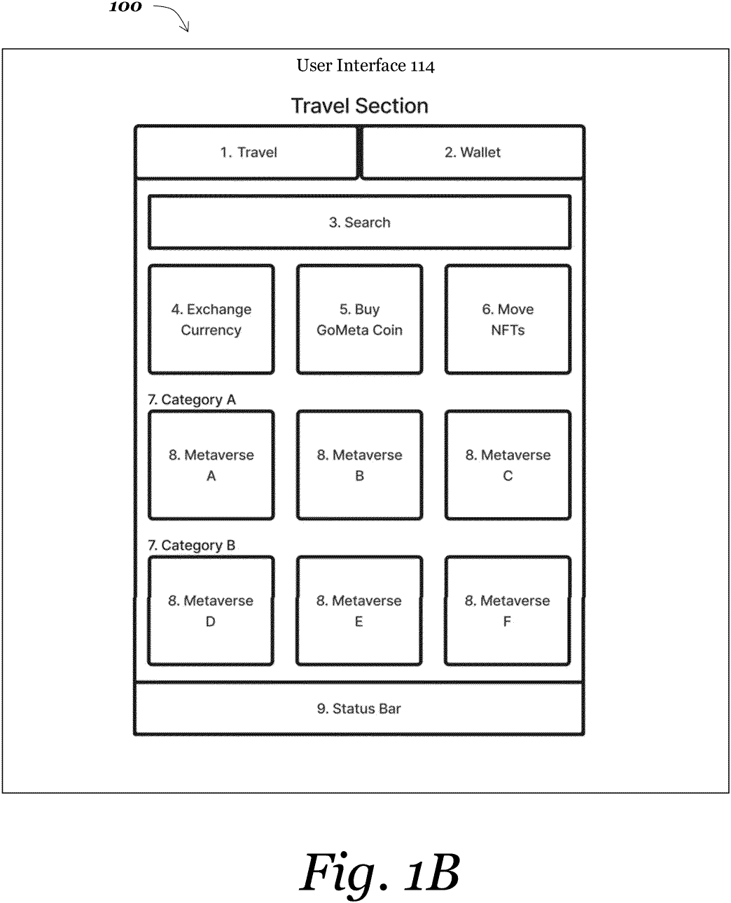

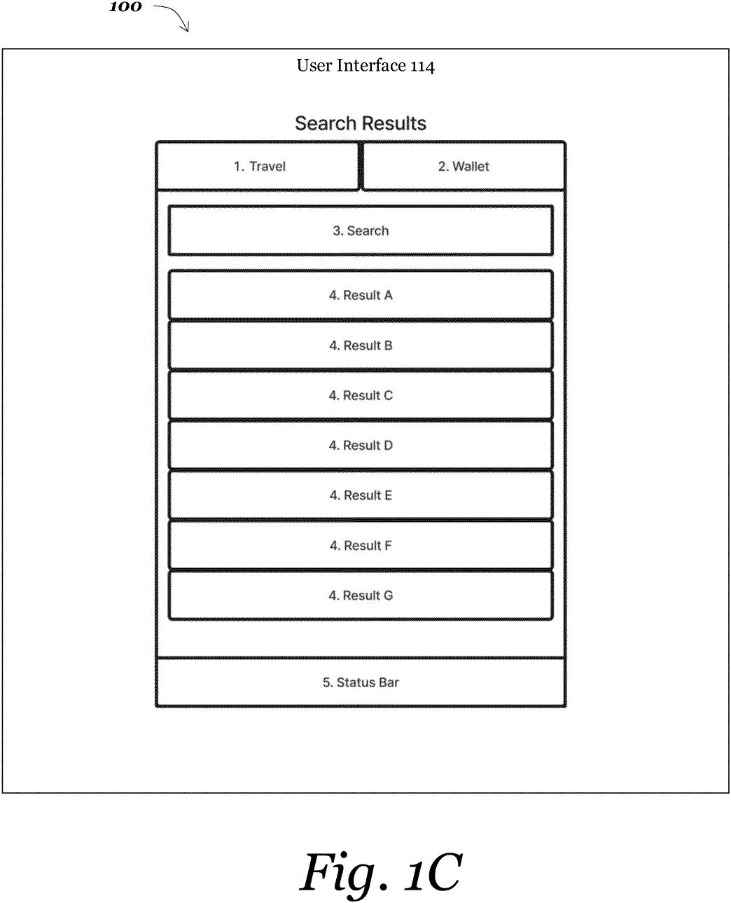

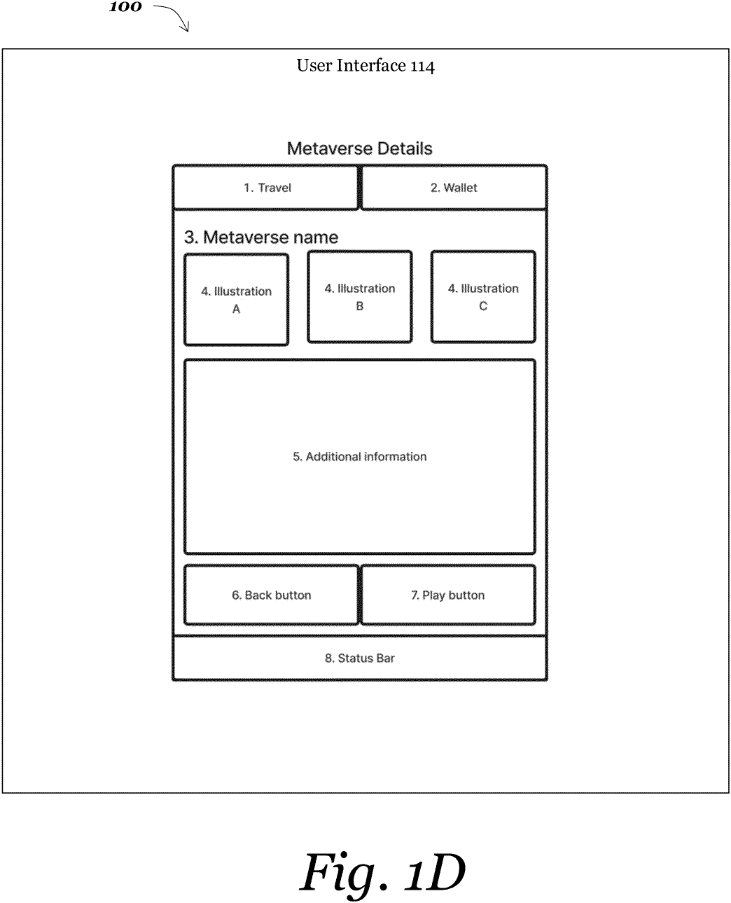

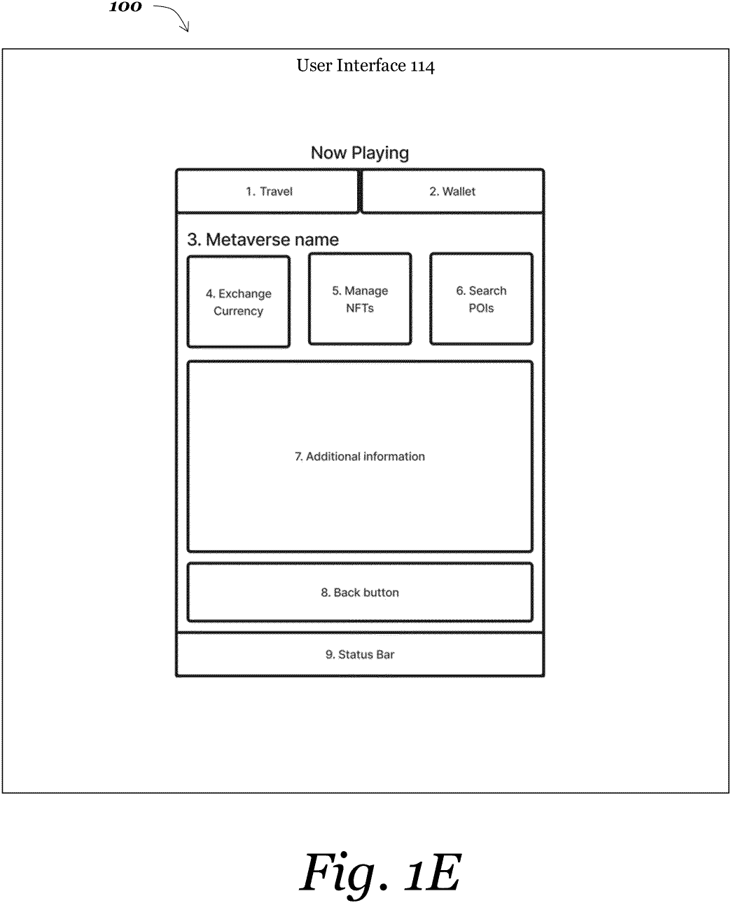

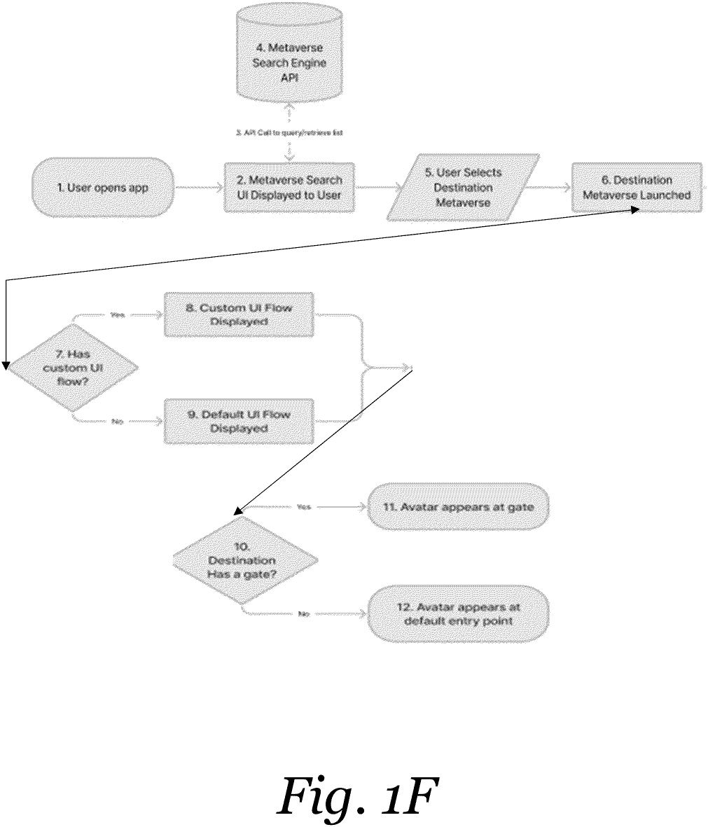

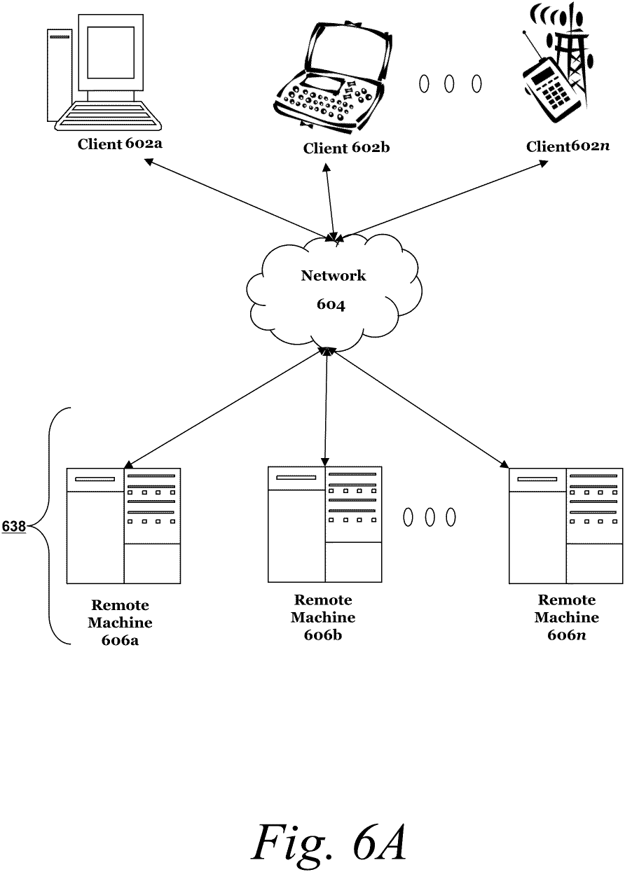

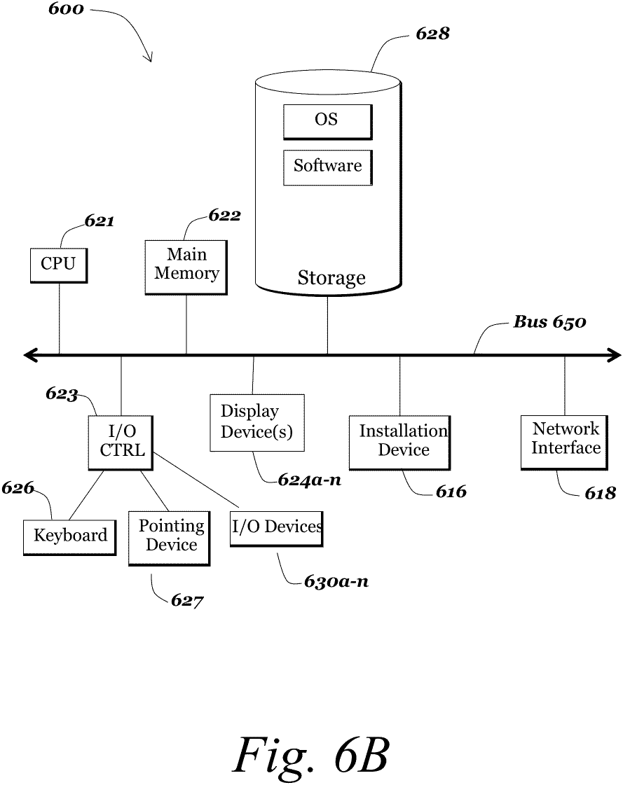

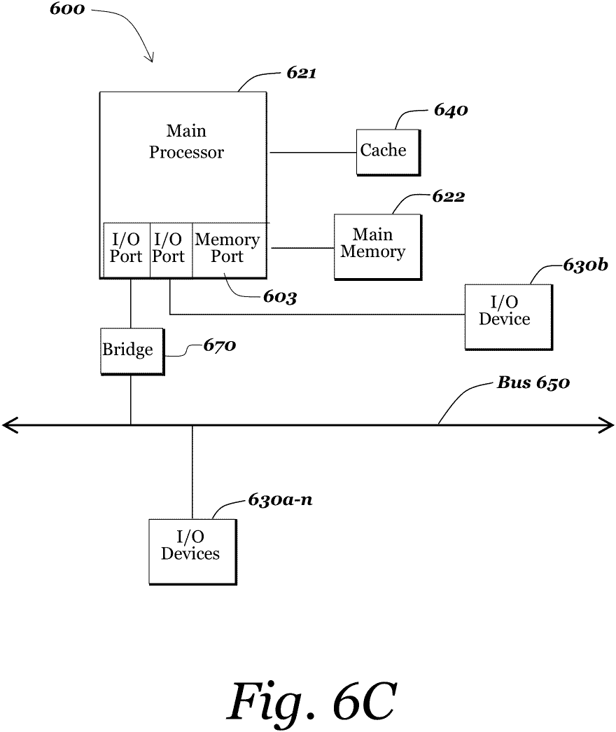

Referring now to FIG. 1A, in brief overview, a system that is configured to transport users from one virtual environment to another includes a computer or gaming device 102, one or more input/output devices 130, a plurality of computing devices 106an, a plurality of event handlers 120a-n, a plurality of user interface engines 112a-n each of which may be associated with at least one virtual environment in a plurality of virtual environments 110a-n. Each user interface engine 112 may generate one or more user interface elements in one or more user interfaces 114 with which a user of the computing device 102 may interact with a virtual environment 110. The computing device and/or gaming device may be a computing device as described below in connection with FIGS. 6A-6C. The computing device 102 may include or be connected to one or more input/output devices 130, including without limitation, gaming peripherals, a mouse, a keyboard, a gamepad, or other interface for controlling on-screen activity. The input/output devices may be Virtual Reality (VR) or Augmented Reality (AR) devices 130. The system displays to the user (e.g., by transmitting data to the computing device 102 for display on a screen of the computing device 102) a user interface providing access to a first virtual environment.

The user interface engines 112a-n (referred to generally herein as user interface engines 112) may include functionality for generating user interfaces and directing the display of the user interfaces to user computing devices 102. The user interface engine 112 may display data received from the computing device 102 within the user interface 114 either to the user or to other users of the virtual environment 110 - for example, by using digital assets received from the computing device 102 as virtual user representations (e.g., an avatar) within the user interface 114. The user interface engines 112a-n may provide access to an identification system with which the system 100 may identify a location in virtual space. By providing means for identifying a specific location in a specific virtual environment that can identify locations across virtual environments, the system 100 provides functionality for identifying user interface elements, locations, and representations of users, which may be used for providing users with means for finding locations within a plurality of virtual environments. Therefore, the system 100 may provide identifiers for destination locations and for origin locations (including for destination virtual environments and for origin virtual environments, as well as for coordinates within those virtual environments) with which to assist users in navigating to and around virtual environments.

The system 100 includes one or more event handlers 120a-n (referred to generally herein as event handlers 120). Each virtual environment 110 may execute one or more event handlers 120. The event handlers 120 may generate and transmit communication data with event handlers 120 in one or more other virtual environments. By modifying a virtual environment to execute an event handler 120 and to route data about interactions by users with user interface elements from a user interface engine 112 of the virtual environment 110 to the event handler 120, and by allowing event handlers 120a-n to communicate with each other via one or more Application Programing Interface (API) connections, the system 100 provides functionality allowing the event handlers to communicate across virtual environments, even if the virtual environments 110a-n do not otherwise provide means for doing so, and this functionality allows for the transfer of control over sessions and users and digital assets associated with users between virtual environments.

Referring now to FIG. 1B, a block diagram depicts an embodiment of a user interface 114 in a system 100 for transferring control over at least one session associated with a user from a first virtual environment in a plurality of virtual environments to a second virtual environment in the plurality of virtual environments. As shown in FIG. 1B, the user interface 114 of the system 100 may include a menu or other user interface that the user may interact with before or during a session in a virtual environment 110. The process for interacting with the user interface 114 may begin after a user downloads a client application 105 from the Apple App Store, Google Play Store or from any similar digital distribution platform that contains the app. The client application 105 may also be in the form of a browser extension, or another code distribution service. Once the client application 105 is installed on the user computing device 102, a user may navigate to the user interface 114 by interacting with the Travel Section Main View, depicted in FIG. 1B. Within this view, a user is able to perform actions which make navigating virtual worlds and metaverse platforms easier.

Selecting the Travel interface element (1) brings the user to the view depicted in FIG. 1B.

Selecting the Wallet Tab interface element (2) navigates the user to the wallet section, where the user may interact with one or more cryptocurrency wallet features.

Selecting the Search Engine (3) interface element allows the user to enter search keywords and customize any available search filters to interact with a Metaverse Search Engine provided by the system 100. When the search is customized, the view can change to the Search Results view depicted in FIG. 1C. When the search is not customized, and is in its default state, the view might return to the Travel Section Main View (FIG. 1B).

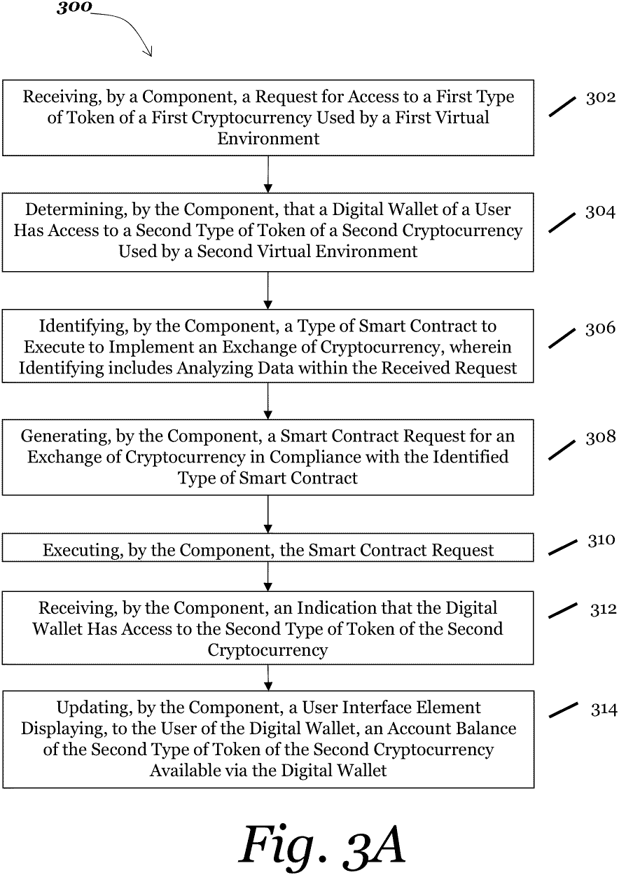

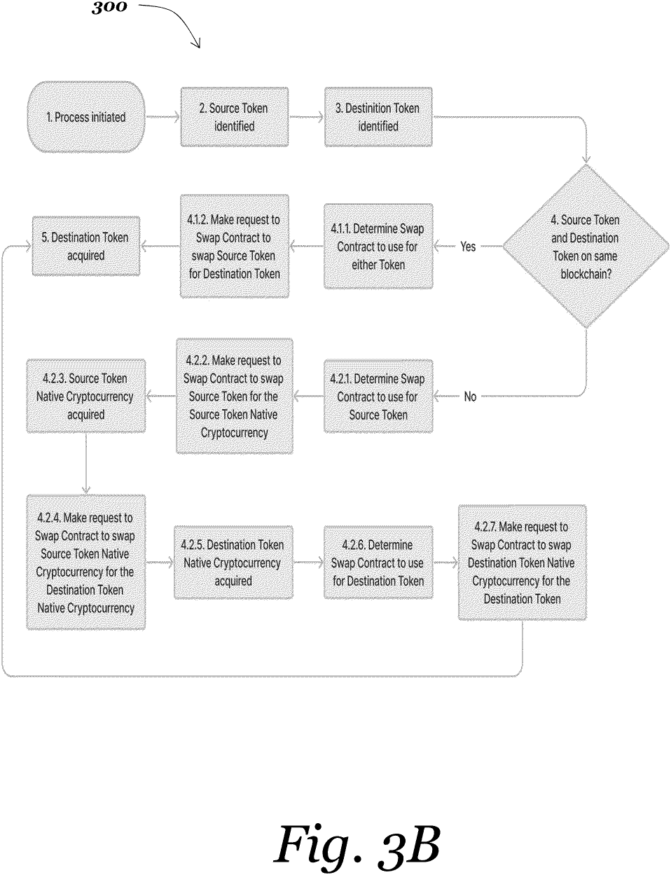

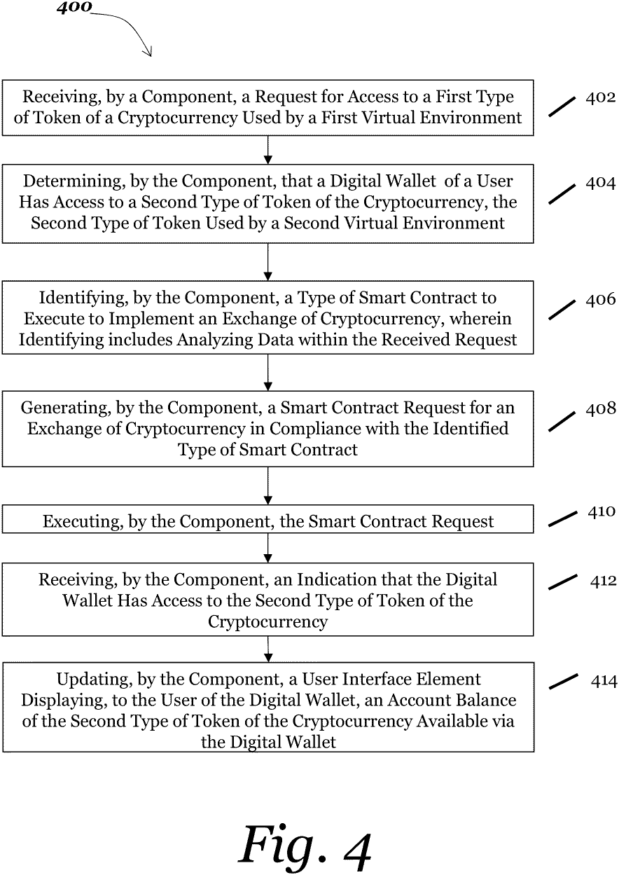

Selecting the Exchange Currency interface element (4) allows the user to convert currency, for example, as described below in connection with FIGS. 3A-B and 4. One function of the client application 105 is to enable the user to convert any supported virtual world or metaverse platform cryptocurrency or blockchain token into any other supported virtual world or metaverse platform cryptocurrency or blockchain token. In one embodiment, this is accomplished by execution of the steps of the methods depicted in FIGS. 3A-B and FIG. 4. In another embodiment, this is accomplished through the use of a third-party cryptocurrency that may be configured to work across multiple blockchains and can serve as the intermediate cryptocurrency or blockchain token between one cryptocurrency or blockchain token and another. If a user is already in possession of such a third-party cryptocurrency, this feature enables them to convert their third-party cryptocurrency into another supported virtual world or metaverse platform cryptocurrency or blockchain token. The third-party cryptocurrency may be provided by an entity providing access to the system 100. The third-party cryptocurrency may also be referred to herein as a “GoMeta Coin.”

Selecting the Buy GoMeta Coin interface element (5) allows the user to purchase a specific type of third-party cryptocurrency. The client application 105 may enable the user to purchase GoMeta Coin, either by converting a supported cryptocurrency or blockchain token into GoMeta Coin, or by using a fiat currency onramp which enables the user to purchase GoMeta Coin using a credit card, debit card, or similar fiat currency purchasing method.

Selecting the Move NFTs interface element (6) may allow the user of the client application 105 to view and interact with and otherwise use one or more NFTs and other digital assets across multiple virtual worlds and metaverse platforms. The client application 105 may enable the movement or transfer of NFTs and other digital assets from one blockchain smart contract to another. For example, although FIGS. 3A-B and 4 refer to exchanging cryptocurrency, these methods may be modified to provide for the transfer of digital assets from one blockchain smart contract to another. As another example, the client application 105 may include functionality cataloging the support of each NFT or digital asset and displaying the information to the user, allowing the user to make informed decisions about which NFTs and digital assets should be acquired, based on the virtual worlds and metaverse platforms that support them.

Selecting the Virtual World and Metaverse Platform Categories interface element (7) provides access to a user interface that may display an enumeration of one or more virtual environments organized in various ways, such as by category, sub-category, publisher, curated collections, etc. Some example categories and sub-categories could be: Real-time strategy (RTS), Action, MMO Arena, Sandbox, Role-playing, Simulation, Sports, Puzzle, Party Games, Action-adventure, Survival, Platformer, Educational, Training, Fashion, and more. Some example curated collections include: Up and coming, Top metaverses, Most recent, Recommended for you, and more. Categorization might also be based on decentralization ranking, which is a ranking based on how decentralized a virtual world or metaverse platform is. This rating is based on a multitude of factors, such as a metric which is based on the ratio of data stored in the blockchain vs data stored in traditional data warehouses.

Selecting the Virtual World or Metaverse Platform Search Results interface element (8) allows a user to see search results, organized in various ways, and to select one to download or launch the app, or to view additional details.

Selecting the Status Bar interface element (9) allows the user to view various pieces of information, such as the progress of any active downloads or updates, notifications, and more. When a virtual world or metaverse platform is currently running, the status bar can show a “now playing” style view, enabling the user to navigate to the Now Playing view.

Referring now to FIG. 1C, a block diagram depicts an embodiment of a user interface 114 in a system 100 for transferring control over at least one session associated with a user from a first virtual environment in a plurality of virtual environments to a second virtual environment in the plurality of virtual environments. As shown in FIG. 1C, a search results interface of the user interface 114 allows a user to view one or more results of executing a search in a metaverse search engine, which provides the user with improved functionality for navigating virtual environments. Entering search keywords or customizing available filters navigates the user to this view. The search results enable the user to find their desired virtual environment. By scrolling through this list, more results can appear on demand. Selecting a search result (4) will navigate the user to the Metaverse Details view. The status bar interface element (5) can show various pieces of information, such as the progress of any active downloads or updates, notifications, and more. When a virtual world or metaverse platform is currently running, the status bar can show a “now playing” style view, enabling the user to navigate to the Now Playing view.

Referring now to FIG. 1D, a block diagram depicts an embodiment of a user interface 114 in a system 100 for transferring control over at least one session associated with a user from a first virtual environment in a plurality of virtual environments to a second virtual environment in the plurality of virtual environments. As shown in FIG. 1D, a Metaverse Details interface in the user interface 114 allows a user to view information associated with a specific virtual environment. Within this view, a user is able to see information about a selected virtual environment. Selecting the Travel Tab interface element (1) navigates the user to the Travel Section Main view (FIG. 1B). Selecting the Wallet Tab interface element (2) (as described in connection with FIG. 1B). The Metaverse name interface element (3) may display the name of a selected virtual environment, along with any other relevant information. The Illustrations interface element (4) may depict one or more illustrations, such as screenshots that may help the user make an informed decision about the experience of the selected virtual environment. The Additional Information interface element (5) may display information such as virtual environment descriptions, tags, statistics, and other data to help the user make an informed decision about the experience of the selected virtual world or metaverse platform. Selecting the Back Button interface element (6) allows the user to navigate to the previous screen. Selecting the Play Button interface element (7) enables the user to download and play their desired virtual world or metaverse platform. If there is currently no virtual world or metaverse platform running, this will launch the desired virtual world or metaverse, which may include a custom UI for new and existing users to prepare to enter the virtual world or metaverse. This may also include the user’s avatar appearing at a gate, if one is installed in the virtual world or metaverse. This travel can also be initiated while a user is currently using a virtual world or metaverse by either switching to the app UI, or by initiating an interaction between their avatar and a gate installed within their current virtual world or metaverse platform. Integrations with virtual worlds and metaverses could in some cases be smoothed out through the use of a curation engine which reacts to certain characteristics of a given virtual world or metaverse platform. The client application 105 can also facilitate the launch of a virtual world or metaverse platform by switching to the appropriate blockchain network within the wallet section of the app. The function of traveling to a virtual world or metaverse platform either within the application 105 or from a gate installed in a given virtual world or metaverse platform could require a cost, which the user may pay using a cryptocurrency or blockchain token or a third-party cryptocurrency such as GoMeta Coin. The Status Bar interface element (8) may display information, such as the progress of any active downloads or updates, notifications, and more. When a virtual world or metaverse platform is currently running, the status bar can show a “now playing” style view, enabling the user to navigate to the Now Playing view.

Referring now to FIG. 1E, a block diagram depicts an embodiment of a user interface 114 in a system 100 for transferring control over at least one session associated with a user from a first virtual environment in a plurality of virtual environments to a second virtual environment in the plurality of virtual environments. As shown in FIG. 1E, a Now Playing interface of the user interface 114 displays information associated with a virtual environment currently executing (e.g., within which the user viewing the user interface 114 has an active session). Selecting the Travel Tab interface element (1) navigates the user to the Travel Section Main view (FIG. 1B). Selecting the Wallet Tab interface element (2) (as described in connection with FIG. 1B). The Metaverse name interface element (3) may display the name of a selected virtual environment, along with any other relevant information. Selecting the Exchange Currency interface element (4) allows the user to convert currency as described above in connection with FIG. 1B. Selecting the Buy GoMeta Coin interface element (5) allows the user to purchase currency as described above in connection with FIG. 1B.

Selecting the Search POIs interface element (6) allows the user to search for and identify one or more Points of Interest (POI) within one or more virtual environments. This may leverage the location positioning system described in greater detail below. In some embodiments, providing users with an interface for searching for and traveling to POIs allows other users, including vendors and brand managers to reach a wider audience than they otherwise would. Many brands currently build their experiences only within the most popular virtual world and metaverse platforms due to a very real fear that users won’t otherwise be able to discover those experiences. This conventional approach may result in a worse experience for users since the top virtual world and metaverse platforms are not always the best experiences to suit the given brand, due to graphical limitations and other aspects of the platform implementations. The methods and systems described herein provide an improved experience that resolves this issue by making it easy for users to find items, experiences, etc. within virtual world and metaverse platforms. This allows brands to build in the best virtual world and metaverse platforms for their target users.

The Additional Information interface element (7) may display information such as virtual environment descriptions, tags, statistics, and other data to help the user make an informed decision about the experience of the selected virtual world or metaverse platform. Selecting the Back Button interface element (8) allows the user to navigate to the previous screen. The Status Bar interface element (8) may display information, such as the progress of any active downloads or updates, notifications, and more.

Therefore, in some embodiments, a user of the computing device 102 may interact with the client application 105 to search for and directly connect to one or more virtual environments. Referring now to FIG. 1F, a flow diagram depicts one embodiment of a method for establishing a connection to a first virtual environment. As depicted in FIG. 1F, the process initiates when the avatar opens the app (1). The metaverse search UI is then displayed to the user (2). A User Interface (UI) is then displayed to the user either from within the application 105, which allows the user to see all of the virtual worlds or metaverse platforms available to them. The initial contents of this interface are fetched using an API Call (3) to the Metaverse Search Engine API (4). The UI is organized in various ways such as by category, sub-category, publisher, curated collections, etc. Some example categories and sub-categories could be: Real-time strategy (RTS), Action, MMO Arena, Sandbox, Role-playing, Simulation, Sports, Puzzle, Party Games, Action-adventure, Survival, Platformer, Educational, Training, Fashion, and more. Some example curated collections include: Up and coming, Top metaverses, Most recent, Recommended for you, and more. The user can search using text entry and filters, which makes additional API Calls (3) to the Metaverse Search Engine API (4) to retrieve an updated list of virtual worlds and metaverse platforms, which subsequently updates the UI with search results. Additional virtual worlds and metaverses can load on demand as the user navigates through the interface, to load additional virtual worlds and metaverse platforms by making additional API Calls (3) to the Metaverse Search Engine API (4).

The metaverse search results may be retrieved via API calls (3) to the metaverse search engine API (4) which allows the user to search for a destination virtual environment. Some example API calls may include: an API call to get the initial list of virtual worlds and metaverse platforms, an API call containing search text and filter options, an API call to get a list of featured virtual worlds or metaverse platforms, etc. Data is returned in data sets which allows for loading of additional results on-demand. The Metaverse Search Engine interfaces with a database containing every virtual world and metaverse platform available for access via the system 100. The data is organized using various tags such as category, sub-category, publisher, collection, etc. This data is stored in a database such as a relational database which maintains relationships between multiple tables to organize the data in such a way that complex queries, data sets, and other advanced data processes are made possible. Interfacing with the API is made possible by API Calls to query/retrieve the list (5) of virtual worlds and metaverse platforms.

The user then selects a destination virtual world or metaverse platform (5). The destination virtual world or metaverse platform is then launched (6).

If the destination virtual world or metaverse platform has a custom user interface (UI) flow (7) then that custom UI flow is displayed to the user (8). To streamline the onboarding process for new and existing users, some virtual worlds and metaverse platforms will opt to have a custom UI flow built into the process of launching the desired metaverse (6). For example, a user may need to enter identifying information such as their email address and name. This data would then be transferred to the destination virtual world or metaverse platform so that all required steps can be completed. Another example might be the customization of a new avatar. The various options could be presented to the user, allowing them to make their desired selections before proceeding to the next stage. In that case, the custom UI flow is displayed (8), otherwise the default UI flow is displayed (9) and the user may complete any relevant steps from directly within the UI of the virtual world or metaverse application, on a website, or a combination of both.

If the destination metaverse or virtual world has a gate (10) then the user’s avatar appears at the gate (11). To select the appropriate entry point for the user’s avatar within the destination virtual world or metaverse platform, the system determines whether the destination virtual world or metaverse platform has a gate installed. In the case that a virtual world or metaverse platform has a gate installed, the user’s avatar will appear at the gate, to simulate the experience of the avatar arriving through that gate. Otherwise, the user’s avatar appears at the default entry point for that virtual world or metaverse platform (12), in the same way that other avatars appear when the virtual world or metaverse platform is launched outside of the methods and systems described herein.

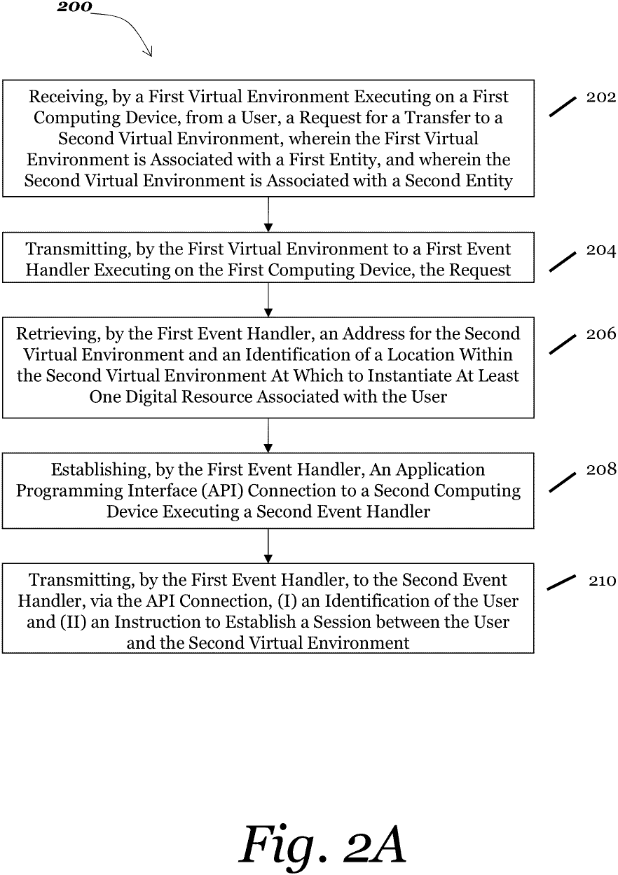

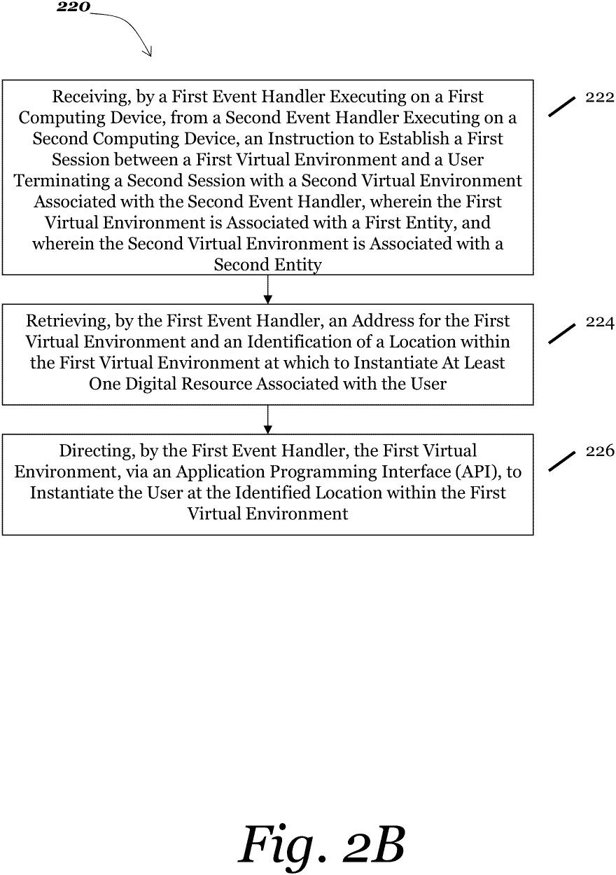

Referring now to FIG. 2A, and in connection with FIGS. 1A-D, a flow diagram depicts one embodiment of a method 200 for transferring control over at least one session associated with a user from a first virtual environment in a plurality of virtual environments to a second virtual environment in the plurality of virtual environments. In brief overview, the method 200 includes receiving, by a first virtual environment executing on a first computing device, from a user, a request for a transfer to a second virtual environment, wherein the first virtual environment is associated with a first entity, and wherein the second virtual environment is associated with a second entity (202). The method 200 includes transmitting, by the first virtual environment to a first event handler executing on the first computing device, the request (204). The method 200 includes retrieving, by the first event handler, an address for the second virtual environment and an identification of a location within the second virtual environment at which to instantiate at least one digital resource associated with the user (206). The method 200 includes establishing, by the first event handler, an Application Programming Interface (API) connection to a second computing device executing a second event handler (208). The method 200 includes transmitting, by the first event handler, to the second event handler, via the API connection, (i) an identification of the user and (ii) an instruction to establish a session between the user and the second virtual environment (210).

The methods and systems describe herein may further facilitate the identification of virtual environments users may access. That is, before the virtual environment 110a receives a request from the user for a transfer to a second virtual environment, the virtual environment 110a may provide the user, via the user interface 114, a user interface element with which the user may view available destinations, within the virtual environment 110a or in one of the plurality of virtual environments 110b-n. The methods and systems described herein may provide a search engine allowing a user to request and receive an enumeration of one or more virtual environments available for access by the user. The system 100 may provide access to an identification of an origin location in virtual space. The system 100 may provide access to an identification of a destination location in virtual space. The system 100 may provide access to an enumeration of a plurality of available virtual environments. The methods and systems described herein may including functionality for assigning a category to a virtual environment in the plurality of virtual environments 110a-n and for using the assigned category when retrieving or generating the enumeration of virtual environments for the user. The system 100 may provide decentralization ranking and may improve the utility of the enumeration for the user.

The methods and systems describe herein may include functionality for generating an identifier that combines an identification of a virtual environment with an identification of a location within a virtual environment and using the identifier to create a virtual environment location positioning system (akin to the Global Positioning System) with which the methods and systems described herein may identify for users locations of particular environments or points of interest. Similarly, the methods and systems describe herein may include functionality for generating an identifier that combines an identification of a virtual environment with an identification of a location within a virtual environment at which a particular user may be found and using that identifier to provide functionality allowing users to search for, locate, and “travel to” other users. The methods and systems described herein may provide functionality allowing a user to search for one or more virtual environments having a particular characteristic or associated metadata. The methods and systems described herein may provide functionality allowing a user to request an enumeration of a plurality of points of interest within one or more virtual environments. The methods and systems described herein may provide functionality allowing a user to request an enumeration of one or more other users interacting with one or more virtual world environments at a time at which the request is received. The system 100 may use the location positioning system to allow the user to travel to a requested person or place. The system 100 may therefore also execute social networking functionality that enables users to add each other as “friends.” Friends would have the ability to see their which virtual environment their friends are interacting with and where they are within that virtual environment, invite friends to join them in a virtual world or metaverse platform, create a friend group which can travel together into a virtual world or metaverse platform, and so on.

Referring now to FIG. 2A, and in greater detail, the method 200 includes receiving, by a first virtual environment executing on a first computing device, from a user, a request for a transfer to a second virtual environment, wherein the first virtual environment is associated with a first entity, and wherein the second virtual environment is associated with a second entity (202). By interacting with a user interface element in the user interface 114, the user may trigger an event from within the virtual environment, which results in generation and transmission of the request to the virtual environment 110a. The user may trigger the event directly (e.g., by selecting a user interface element such as a menu or by typing in or dictating a command or, in a first person viewer environment, by interacting directly with a user interface element in the user interface) or indirectly (e.g., by directing the user’s avatar to interact with an element displayed in the user interface element). Triggering an event may be done by entering a room or other virtual environment displayed by the user interface 114; therefore, the method 200 may include receiving an indication that a digital representation of the user is rendered at a location in the first virtual environment from which users may request transfers out of the first virtual environment. Triggering an event may occur when a user interacts with a particular user interface element displayed by the user interface 114; for example, the user may interact with a depiction of a gate or a sign listing available destinations. Gates may be any in-game element that has been intended to initiate such requests, such as - but not limited to - a door or portal that the avatar enters or an in-game item which encompasses the avatar.

The method 200 includes transmitting, by the first virtual environment to a first event handler executing on the first computing device, the request (204). When the user triggers the event from within the origin virtual environment 110a, the origin virtual environment 110a executes an event handler 120a (and/or transmits an instruction to an already executing event handler 120a) that connects to an API and sends relevant information about the user and their desired destination. The user interface engine 112 may be configured to receive user input provided to the user interface associated with certain events and to transmit the received user input to the event handler 120a for further processing.

The method 200 includes retrieving, by the first event handler, an address for the second virtual environment and an identification of a location within the second virtual environment at which to instantiate at least one digital resource associated with the user (206). The event handler 120a may access a data structure enumerating virtual environments and their associated addresses and locations. The event handler 120a may use information included in the request to retrieve the information associated with the virtual environment requested by the user in the request; for example, the data structure (not shown) may map a user friendly name of a virtual environment to a computer processable address to which the event handler 120a may transmit data relating to the request, such as an address with which the event handler 120a may establish a connection with an event handler 120b or otherwise establish an API connection with a computing device associated with an entity providing access to the requested virtual environment 110b.

The method 200 includes establishing, by the first event handler, an Application Programming Interface (API) connection to a second computing device executing a second event handler (208). The method 200 includes transmitting, by the first event handler, to the second event handler, via the API connection, (i) an identification of the user and (ii) an instruction to establish a session between the user and the second virtual environment (210). The information transmitted via the API connection may include an identification of a location within the virtual environment 110b at which the event handler 120b should display an avatar of the user. The information transmitted via the API connection may include an identification of one or more digital assets associated with the user that the user may interact with once the user has begun to interact with a user interface of the virtual environment 110b; for example, an “inventory” or other enumeration of digital assets available to the user. In some embodiments, as will be described in greater detail below, the event handler 120b will retrieve information identifying a crypto wallet associated with the user to ensure that the user has the opportunity to acquire cryptocurrency acceptable for use in the second virtual environment 110b if the user does not already have such cryptocurrency in her crypto wallet. The event handler 120b may also provide the user with an opportunity to acquire third-party cryptocurrency for use in the virtual environment 110b. As will be understood by those of skill in the art, digital assets may include Non-Fungible Tokens (NFTs) and other data representing 3D clothing, avatars, designer avatar skins, avatar clothing, avatar equipment, and avatar accessories generally.

The event handler 120b may then direct the establishment of a session between the computing device 102 and the virtual environment 110b, effectively redirecting the user to a computing device 106b associated with the virtual environment 110b, optionally automating a log-on process on behalf of the user by, for example and without limitation, accessing log-on information (such as account credentials, avatar customization data, etc.) associated with the user (e.g., optionally included in the user’s crypto wallet. Depending on the implementation of the virtual environment 110, different user interface elements may be displayed allowing the user to configure their experience within the virtual environments. By way of example, the user may choose to store one or more sets of log-in credentials or digital assets or other user data in the crypto wallet that the system 100 is authorized to access. As another example, the user or the virtual environment 110 may specify a graphical display the user should be shown when the user is transitioning from a first virtual environment to a second.

The second event handler 120b may receive, from the second virtual environment, a request for access to a digital asset associated with the user and which was used within the first virtual environment. The second event handler 120b may request, from a digital wallet of the user, access to the digital asset. The second event handler 120b may receive from the digital wallet, an instruction for accessing a location of the digital asset on a block chain. The second event handler 120b may provide to the second virtual environment, access to the digital asset.

The first event handler 120a may terminate a user session with the virtual environment 110a once the event handler 120b provides an indication that the event handler 120b has established a new user session for the user in the virtual environment 110b.

In some embodiments, the API connection is not necessary; for example, if a user is moving from one location with the virtual environment 110a to another location within the same virtual environment 110a or in an embodiment in which user information and destination information are not required to make the transition of the user session.

The user is thus able to “travel” from an origin location in virtual space in the first virtual environment 110a to a destination location in virtual space within the destination virtual world or metaverse platform. The user, represented by either the same or a different virtual user representation (i.e., avatar), then continues their experience within the destination virtual world or metaverse platform. Traveling, as will be understood by those of ordinary skill in the art may include moving from a first virtual space (e.g., a user interface designed to represent a location in an environment, giving the user the impression that their avatar is physically located in a place) in a first virtual environment to a second virtual space in the same virtual environment or to a second virtual space in a different virtual environment. By way of example and without limitation, a user may wish to travel from a first point of interest in a first virtual environment - such as within a user interface customized to look like a home for the user’s avatar - to a second point of interest in the first virtual environment - such as an area of the virtual environment customized by a second user to look like a home or store or interactive area in which the user’s avatar may interact either alone or with the second user’s avatar. As another example, and without limitation, a user may be traveling from a home location in a first virtual environment such as a ROBLOX virtual environment provided by the Roblox Corporation of San Mateo, CA, to a home location in a DECENTRALAND virtual environment provided by the Decentraland Foundation of Carlsbad, CA.

Although in a conventional approach a virtual environment may provide the user with a link to an external and/or third party site from which the user may log in to and access a different virtual environment, this would be an immersion-breaking experience for the user. In contrast, the metaverse transport system of the present disclosure is configured to seamlessly transport users from within a user interface of a first virtual environment into a user interface of a second virtual environment while avoiding immersion-breaking experiences for the user.

Referring now to FIG. 2B, and in connection with FIG. 1-2A, a flow diagram depicts one embodiment of a method 220 for transferring control over at least one session associated with a user from a first virtual environment in a plurality of virtual environments to a second virtual environment in the plurality of virtual environments. In brief overview, the method 220 includes receiving, by a first event handler executing on a first computing device, from a second event handler executing on a second computing device, an instruction to establish a first session between a first virtual environment and a user terminating a second session with a second virtual environment associated with the second event handler, wherein the first virtual environment is associated with a first entity and the second virtual environment is associated with a second entity (222). The method 220 includes retrieving, by the first event handler, an address for the first virtual environment and an identification of a location within the first virtual environment at which to instantiate at least one digital resource associated with the user (224). The method 220 includes directing, by the first event handler, the first virtual environment, via an Application Programming Interface (API), to instantiate the user at the identified location within the first virtual environment (226).

Referring now to FIG. 2B, and in greater detail, the method 220 includes receiving, by a first event handler executing on a first computing device, from a second event handler executing on a second computing device, an instruction to establish a first session between a first virtual environment and a user terminating a second session with a second virtual environment associated with the second event handler, wherein the first virtual environment is associated with a first entity and the second virtual environment is associated with a second entity (222). The event handlers 120 may exchange instructions regarding establishing sessions on behalf of virtual environment users as described above in connection with FIG. 2A.

The method 220 includes retrieving, by the first event handler, an address for the first virtual environment and an identification of a location within the first virtual environment at which to instantiate at least one digital resource associated with the user (224). The event handlers 120 may retrieve data for use in establishing sessions on behalf of virtual environment users as described above in connection with FIG. 2A.

The method 220 includes directing, by the first event handler, the first virtual environment, via an Application Programming Interface (API), to instantiate the user at the identified location within the first virtual environment (226). The event handlers 120 may exchange API calls with the user interface engines 112 to direct the establishment of sessions on behalf of virtual environment users as described above in connection with FIG. 2A.

The event handler 120b may receive, from the virtual environment 110b, a request for access to a digital asset associated with the user and optionally used by the user within the virtual environment 110a. The event handler 120b may request, from a digital wallet of the user, access to the digital asset. The event handler 120b may receive, from the digital wallet, an instruction for accessing a location of the digital asset on a block chain. The event handler 120b may provide, to the virtual environment 110b, access to the digital asset.

Referring back to FIG. 1F, which described the process for connecting a user to a virtual environment, the method 200 may begin when the user enters a particular region of the user interface of the virtual environment 110 or when the user opens the client application 105, as shown in FIG. 1F. If the user enters a region of the user interface of the virtual environment with a gate or other interface element that may trigger an option to travel to another virtual environment, in some embodiments, the method 200 may follow the same steps as those depicted in FIG. 1F subsequent to the step of the user opening the client application 105.

The methods and systems described herein may therefore provide functionality allowing users to seamless transition from executing a first virtual environment to executing a second virtual environment, including transitioning display of a digital representation of the users within the first virtual environment to displaying the digital representation of the users within the second virtual environment; this may be referred to as traveling between virtual environments. The methods and systems describe herein may provide a technical solution to the challenges that arise from the multiple frameworks and platforms required by conventional systems, which result in difficult, confusing, and inconvenient methods for transitioning user access from a first virtual environment to a second virtual environment. Therefore, the methods and systems described herein may provide improved technical functionality for “transporting a user” – including, without limitation, ending a user interaction with a first virtual environment, including directing execution of any processes required to end a connection between a computing device of the user and at least one computing device providing access to the virtual environment and initiating a session between the computing device of the user and at least one computing device providing access to the second virtual environment - and may provide such functionality for connecting a plurality of virtual environments regardless of whether the type of technology platform on which each of the plurality of virtual environments execute differs from one virtual environment to another. The methods and systems described herein may further include execution of system functionality for giving users the perception that events are occurring in real-time within one or more virtual environments and to which users may travel.

The methods and systems described herein may further provide functionality allowing the exchange of one cryptocurrency or token to another, through the use of what are referred to as smart contracts. Virtual environments may use the same or different tokens within a single cryptocurrency or may use the same or different tokens within different cryptocurrencies and may require access to a variety of platforms and blockchain technologies. However, conventional systems do not typically provide functionality supporting users in converting the contents of their digital wallets (also referred to herein as crypto wallets) from the currency used by a first virtual environment to the currency used by a second virtual environment when “traveling” between virtual environments.

In some embodiments, the methods and systems described herein may integrate the functionality for transporting a user from a first virtual environment to a second virtual environment with functionality for accessing and/or modifying a type of cryptocurrency within a user’s crypto wallet. By including functionality such as an event handler executing within each virtual environment that a user may access and by configuring the event handler to securely connect to a user’s crypto wallet from within the virtual environment, the methods and systems described herein provide functionality that allows a user to access digital assets – including currency and avatars and other digital assets – when interacting with a first virtual environment and to continue accessing those assets seamlessly when interacting with a second virtual environment.

As will be understood by those of skill in the art, a digital wallet may refer to any application (in software or hardware; executed by a device of the user or by the user accessing an internet-based application) that stores one or more sources of currency for a user of the digital wallet; if the user owns cryptocurrency and stores within the digital wallet the cryptocurrency (either by storing the cryptocurrency itself or by storing credentials providing access to a source of the cryptocurrency), the digital wallet may be referred to as a crypto wallet. By way of example and without limitation, digital wallets conventionally available may include applications such as the APPLE PAY digital wallet service offered by Apple, GOOGLE PAY provided by Google, SAMSUNG PAY provided by Samsung, and PAYPAL. Cryptocurrency wallets may refer to a device, physical medium, program or a service which contains pairs of public and private cryptographic keys. A cryptocurrency wallet offers the functionality of encrypting and/or signing information that can result in executing a transaction (e.g., a smart contract, a cryptocurrency transaction, etc.). The keys can also be used to track ownership. For example, cryptocurrencies are decentrally stored and maintained in a publicly accessible distributed ledger called the blockchain. A public key allows others to make payments to the address derived from it, whereas a private key enables the spending of cryptocurrency from that address. By way of example and without limitation, crypto wallets conventionally available may include applications such as the Crypto.com DeFi Wallet provided by Foris DAX, Inc., of Miami, FL and the Metamask crypto wallet application provided by ConsenSys Software Inc., of New York, NY. Crypto wallets may also provide access to non-currency digital assets, including NFTs, avatars, and avatar skins.

As will be further understood by those of skill in the art, a digital currency that is used in a decentralized network known as a blockchain may be referred to as a cryptocurrency. A blockchain may implement one or more tokens. A blockchain may only implement one native asset but may have a virtually infinite number of tokens built on top of it. A swap may refer to the exchange of one token or cryptocurrency with another. A smart contract may refer to software code deployed to a blockchain that serves one or more functions. These can often have requests made to them for various desired results.

A blockchain’s inherent or native type of asset or digital currency may be referred to as a native cryptocurrency. This currency may also be referred to as a “native token,” “protocol token,” “intrinsic token” or “built-in token.” In the case of the blockchain referred to as Bitcoin, for example, the only purpose of the blockchain is to act as a cryptocurrency, and its native symbol is described as BTC. In contrast, Ethereum’s native crypto is ether (ETH); however, along with NFTs and numerous other smart contractbased tokens, Ethereum hosts countless non-native cryptocurrencies. Every independent blockchain has its own native crypto that is used to reward miners and validators for adding blocks to the blockchain and as a payment medium for transaction fees.

Referring now to FIG. 3 in brief overview and in connection with FIGS. 1 and 2A-B, a flow diagram depicts an embodiment of a method 300 for converting, from within one of a plurality of virtual environments, by a digital wallet, one of a plurality of cryptocurrencies into a second of the plurality of cryptocurrencies, the second of the plurality of cryptocurrencies used within the one of the plurality of virtual environments. The method 300 includes receiving, by a component, a request for access to a first type of token of a first cryptocurrency used by a first virtual environment (302). The method 300 includes determining, by the component, that the digital wallet has access to a second type of token a second cryptocurrency used by a second virtual environment (304). The method 300 includes identifying, by the component, a type of smart contract to execute to implement an exchange of cryptocurrency, wherein identifying further comprises analyzing data within the received request (306). The method 300 includes generating, by the component, a smart contract request for an exchange of cryptocurrency in compliance with the identified type of smart contract (308). The method 300 includes executing, by the component, the smart contract request (310). The method 300 includes receiving, by the component, an indication that the digital wallet has access to the second type of token of the second cryptocurrency (312). The method 300 includes updating, by the component, a user interface element displaying, to a user of the digital wallet, an account balance of the second type of token of the second cryptocurrency available via the digital wallet (314).

Referring now to FIG. 3 in greater detail, the method 300 includes receiving, by a component, a request for access to a first type of token of a first cryptocurrency used by a first virtual environment (302). The component may be an event handler 120. The component may be a subcomponent of the event handler 120. The component may be a separate module in communication with the event handler 120. The component may include functionality for communicating with the event handler 120. The component may include functionality for interacting with a digital wallet of a user of a virtual environment 110. The component may be a smart contract node in communication with the vent handler 120.

The method 300 includes determining, by the component, that the digital wallet has access to a second type of token a second cryptocurrency used by a second virtual environment (304). The component may determine that the first type of token is the same type as the second type of token and that the first cryptocurrency uses a different blockchain than the second cryptocurrency. The component may determine that the first type of token is a different type than the second type of token and that the first cryptocurrency uses a different blockchain than the second cryptocurrency. The component may determine that the first type of token is the same type as the second type of token and determining that the first cryptocurrency uses the same blockchain as the second cryptocurrency. The component may determine that the first type of token is a different type as the second type of token and determining that the first cryptocurrency uses the same blockchain than the second cryptocurrency. The type of tokens and the type of cryptocurrency being exchanged may impact the type of smart contract that can be used to exchange tokens of cryptocurrency from a form already owned by the user of the digital wallet into a form usable by the user in a different virtual environment 110.

The method 300 includes identifying, by the component, a type of smart contract to execute to implement an exchange of cryptocurrency, wherein identifying further comprises analyzing data within the received request (306). The component may identify a type of swap contact.

The method 300 includes generating, by the component, a smart contract request for an exchange of cryptocurrency in compliance with the identified type of smart contract (308). The method 300 includes executing, by the component, the smart contract request (310). The method 300 includes receiving, by the component, an indication that the digital wallet has access to the second type of token of the second cryptocurrency (312). The method 300 includes updating, by the component, a user interface element displaying, to a user of the digital wallet, an account balance of the second type of token of the second cryptocurrency available via the digital wallet (314).

Referring now to FIG. 4, in brief overview and in connection with FIGS. 1-3, a flow diagram depicts an embodiment of a method 400 for converting, from within one of a plurality of virtual environments, by a digital wallet, one of a plurality of cryptocurrencies into a second of the plurality of cryptocurrencies, the second of the plurality of cryptocurrencies used within the one of the plurality of virtual environments. The method 400 includes receiving, by a component, a request for access to a first type of token in a cryptocurrency used by a first virtual environment (402). The method 400 includes determining, by the component, that the digital wallet has access to a second type of token of the cryptocurrency, the second type of token used by a second virtual environment (404). The method 400 includes identifying, by the component a type of smart contract to execute to implement an exchange of cryptocurrency, wherein identifying further comprises analyzing data within the received request (406). The method 400 includes generating, by the component, a smart contract request for an exchange of cryptocurrency in compliance with the identified type of smart contract (408). The method 400 includes executing, by the component, the smart contract request (410). The method 400 includes receiving, by the component, an indication that the digital wallet has access to the second type of token of the cryptocurrency (412). The method 400 includes updating, by the component, a user interface element displaying, to a user of the digital wallet, an account balance of the second type of the cryptocurrency available via the digital wallet (414). The method 400 may be executed in the manner described in connection with the method 300 of FIG. 3, however the type of smart contract identified for execution at (406) differs since in the method 400 the exchange of cryptocurrency is between different tokens in use by the same cryptocurrency.

Referring now to FIG. 3B, and in connection with FIG. 3A and FIG. 4, a flow chart depicts one embodiment of the method 300 for converting cryptocurrency for use in a virtual environment. The method 300 may begin execution upon a smart contract node receiving a request to initiate the method. By way of example, the smart contract node may receive the request from an event handler 120.

The Source Token is identified (2). The Source Token may be identified by analyzing one or more arguments in the smart contract address included in the request. Arguments may include a Source Token smart contract address, a Source Token blockchain, a Source Token Native Cryptocurrency, and an amount of Source Token that will be swapped.

The Destination Token is identified (3). The Destination Token may be identified by analyzing one or more arguments in the smart contract address included in the request.

The method includes determining whether the Source Token and Destination Token are on the same blockchain (4). The method may include comparing one or more characteristics of the Source Token with one or more characteristics of the Destination Token. If the tokens are found to be tokens on the same blockchain, then the method includes determining which Swap Contract to use for either token (4.1.1). The method may include determining which Swap Contract to use by analyzing variables such as the type of blockchain used and the Source Token and Destination Token contract addresses. Once the Swap Contract is selected (e.g., from a database), the method includes making a request to that Swap Contract to swap the Source Token for the Destination Token (4.1.2). The request may include information needed to make the swap, including for example the Source Token smart contract address and the amount of Source Token to be swapped, along with any other required information as specified by the Swap Contract. Once that Swap Contract request completes, the Destination Token will have been acquired (5) at which point the process is complete.

On the other hand, if the Source Token and Destination Token are not found to be tokens on the same blockchain (4), then the method includes determining which swap contract to use for the Source Token (4.2.1) before making a request to that Swap Contract to swap the Source Token for the Source Token Native Cryptocurrency (4.2.2). As indicated above, the method may include selecting a Swap Contract (e.g., from a variable) based on analyzing one or more variables such as the blockchain used and the Source Token contract address. As indicated above, the method may include generating a request in compliance with one or more requirements of the Swap Contracts and transmitting the request to the Swap Contract node. Once that Swap Contract request completes, the Source Token Native Cryptocurrency will have been acquired (5) at which point the process is complete. At that point the method may include generating a request to a Smart Contract to swap the source token native cryptocurrency for the destination token native cryptocurrency (4.2.4). The request may include any information specified by the Smart Contract as necessary for making the swap. Once the smart contract request is completed, the destination token native cryptocurrency will have been acquired for the user. Based on variables such as the blockchain used, and the Destination Token contract address, a suitable Swap Contract is selected from a database. The method then includes requesting a swap of the acquired destination native cryptocurrency for the destination token originally requested.

In this way, the methods and systems described herein provide functionality allowing a user to exchange either tokens of a single type of cryptocurrency for different tokens of the same cryptocurrency or tokens of one type of cryptocurrency for tokens of another type of cryptocurrency.

In one embodiment, the methods and systems described herein provide functionality implementing a universal token exchange. Unlike a conventional exchange that requires pairing one or more tokens with one or more liquidity pools (and therefore require setup and capital for each liquidity pool), the functionality described herein may implement a smart contract that uses existing swap contracts to swap a first type of token for a base currency (e.g., ETH, BTC, MATIC, BNB, etc.) and then swap the base currency for a second type of token using a second smart contract. Since swap contracts already exist for each token, the real-time linking of two swap contract transactions enables an improved technological solution for using the existing contracts and liquidity pool to enable a swap of one type of token for another. As would be understood by one of ordinary skill in the art, a third (or more) swap contract may be used in between to swap a base currency for another base currency, thus providing a bridge between different blockchain networks and allowing the exchange of different types of tokens on different blockchain networks.

Unlike conventional digital wallets that connect to one blockchain network at a time, and which require users to switch to a different blockchain network before accessing cryptocurrency of another blockchain network, the methods and systems described herein provide an improved digital wallet that allows simultaneous connections to a plurality of blockchain networks. One benefit of such an improved digital wallet is that users may perform actions on any of a plurality of blockchain networks without explicitly disconnecting the digital wallet from one and changing to another. As an example of this benefit, a user may not even need to know what blockchain network is required for a particular digital token - the user may be able to specify a source token and a destination token and have the methods and systems described herein execute to identify the swap contracts (and/or smart contracts) for the specified tokens on the associated blockchain networks and make the exchange without additional input from the user. Furthermore, the methods and systems described herein may provide functionality for tracking the token and cryptocurrency balances across multiple blockchains by persisting multiple concurrent blockchain network connections at one time. This prevents the need for the user to manually switch between blockchain networks to interact with a given blockchain.

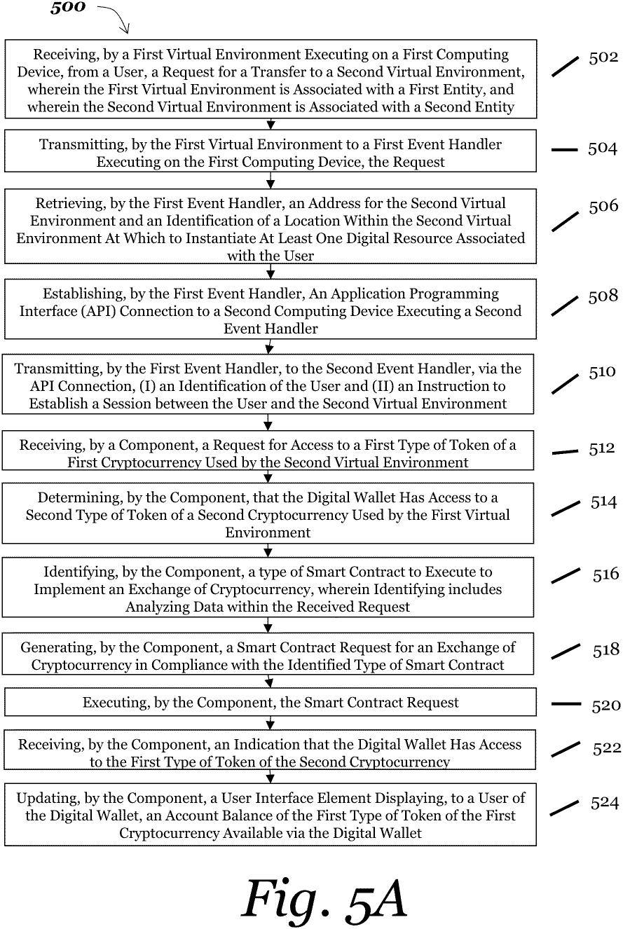

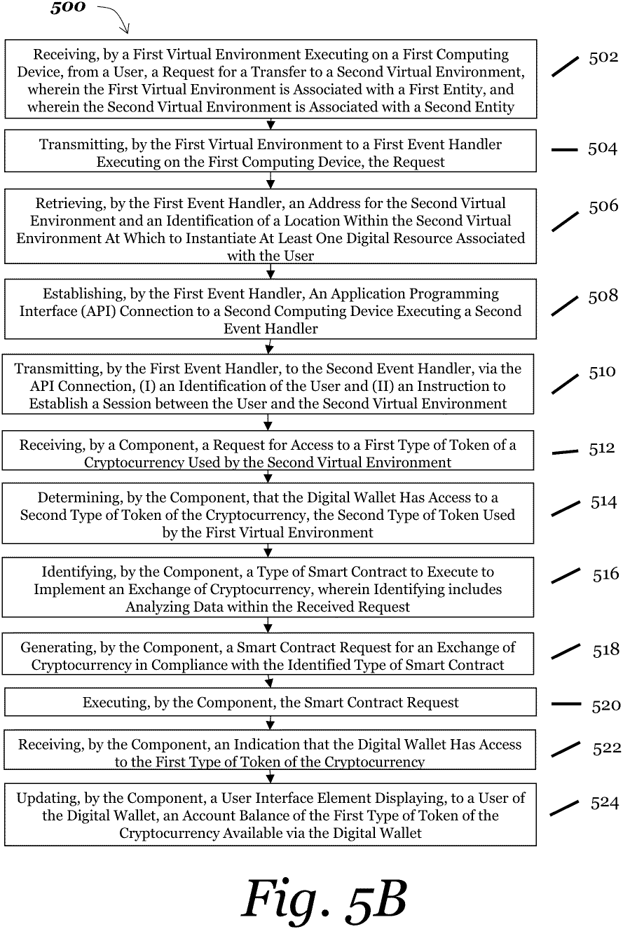

Referring now to FIG. 5A, in brief overview and in connection with FIGS. 1-4, a flow diagram depicts one embodiment of a method 500 for transferring control over at least one session associated with a user from a first virtual environment in a plurality of virtual environments to a second virtual environment in the plurality of virtual environments. The method 500 includes receiving, by a first virtual environment executing on a first computing device, from a user, a request for a transfer to a second virtual environment, wherein the first virtual environment is associated with a first entity and the second virtual environment is associated with a second entity (502). The method 500 includes transmitting, by the first virtual environment to a first event handler executing on the first computing device, the request (504). The method 500 includes retrieving, by the first event handler, an address for the second virtual environment and an identification of a location within the second virtual environment at which to instantiate at least one digital resource associated with the user (506). The method 500 includes establishing, by the first event handler, an Application Programming Interface (API) connection to a second computing device executing a second event handler (508). The method 500 includes transmitting, by the first event handler, to the second event handler, via the API connection, (i) an identification of the user and (ii) an instruction to establish a session between the user and the second virtual environment (510). The method 500 includes receiving, by a component, executed by the second event handler, a request for access to a first type of token in a cryptocurrency used by the second virtual environment (512). The method 500 includes determining, by the component, that the digital wallet has access to a second type of token of the cryptocurrency, the second type of token used by the first virtual environment (514). The method 500 includes identifying, by the component a type of smart contract to execute to implement an exchange of cryptocurrency, wherein identifying further comprises analyzing data within the received request (516). The method 500 includes generating, by the component, a smart contract request for an exchange of cryptocurrency in compliance with the identified type of smart contract (518). The method 500 includes executing, by the component, the smart contract request (520). The method 500 includes receiving, by the component, an indication that the digital wallet has access to the first type of token of the cryptocurrency (522). The method 500 includes updating, by the component, an account balance of the first type of the first token of the cryptocurrency available via the digital wallet (524). The method 500 may be executed by executing the method 200 of FIG. 2A and the method 400 of FIG. 4.

Referring now to FIG. 5B, in brief overview and in connection with FIGS. 1-4, a flow diagram depicts an alternate embodiment of the method 500 for transferring control over at least one session associated with a user from a first virtual environment in a plurality of virtual environments to a second virtual environment in the plurality of virtual environments. The method 500 includes receiving, by a first virtual environment executing on a first computing device, from a user, a request for a transfer to a second virtual environment, wherein the first virtual environment is associated with a first entity and the second virtual environment is associated with a second entity (502). The method 500 includes transmitting, by the first virtual environment to a first event handler executing on the first computing device, the request (504). The method 500 includes retrieving, by the first event handler, an address for the second virtual environment and an identification of a location within the second virtual environment at which to instantiate at least one digital resource associated with the user (506). The method 500 includes establishing, by the first event handler, an Application Programming Interface (API) connection to a second computing device executing a second event handler (508). The method 500 includes transmitting, by the first event handler, to the second event handler, via the API connection, (i) an identification of the user and (ii) an instruction to establish a session between the user and the second virtual environment (510). The method 500 includes receiving, by a component, executed by the second event handler, a request for access to a first type of token in a first cryptocurrency used by the second virtual environment (512). The method 500 includes determining, by the component, that a digital wallet of the user has access to a second type of token of a second cryptocurrency used by the first virtual environment (514). The method 500 includes identifying, by the component a type of smart contract to execute to implement an exchange of cryptocurrency, wherein identifying further comprises analyzing data within the received request (516). The method 500 includes generating, by the component, a smart contract request for an exchange of cryptocurrency in compliance with the identified type of smart contract (518). The method 500 includes executing, by the component, the smart contract request (520). The method 500 includes receiving, by the component, an indication that the digital wallet has access to the first type of token of the first cryptocurrency (522). The method 500 includes updating, by the component, an account balance of the first type of token of the first cryptocurrency available via the digital wallet (524). The method 500 may be executed by executing the method 200 of FIG. 2A and the method 300 of FIG. 3A.

Through custom development, a software development kit installation, or another method of modifying a virtual environment to execute the methods and systems described herein, one or more features of these systems may be integrated directly into the virtual environments themselves, making it easier for users to access the features of these methods and systems from within a given virtual world or metaverse platform. Furthermore, certain experience customizations may be offered to the user through a subscription, retail- purchase, or another method of sale which enables the user to customize various aspects of their experience. One such experience customization might be a graphical visualization of the travel to and from virtual worlds or metaverse platforms, such as a visualization of flying in a plane or spacecraft, riding in a train or bus, and other user experiences.

Furthermore, the methods and systems described herein may be embedded directly into a third party digital wallet. Another use case variation for the crypto wallet would allow for a user to purchase a virtual product (e.g., Avatar, Avatar Clothing, Virtual House, Virtual Car, etc.) with the crypto wallet. These virtual products (digital assets) can be stored in their crypto wallet and travel with them (like a digital suitcase) and utilized (unpacked) in the other virtual worlds or metaverses that they wish to travel to.

A third party application or service may leverage the API calls for interacting with event handlers 120 to directly access the system 100. A web site may embed the functionality for directly accessing the functionality described herein.

In some embodiments, the system 100 includes non-transitory, computer-readable medium comprising computer program instructions tangibly stored on the non-transitory computer-readable medium, wherein the instructions are executable by at least one processor to perform each of the steps described above in connection with FIGS. 2-5.

It should be understood that the systems described above may provide multiple ones of any or each of those components and these components may be provided on either a standalone machine or, in some embodiments, on multiple machines in a distributed system. The phrases ‘in one embodiment,’ ‘in another embodiment,’ and the like, generally mean that the particular feature, structure, step, or characteristic following the phrase is included in at least one embodiment of the present disclosure and may be included in more than one embodiment of the present disclosure. Such phrases may, but do not necessarily, refer to the same embodiment. However, the scope of protection is defined by the appended claims; the embodiments mentioned herein provide examples.

The terms “A or B”, “at least one of A or/and B”, “at least one of A and B”, “at least one of A or B”, or “one or more of A or/and B” used in the various embodiments of the present disclosure include any and all combinations of words enumerated with it. For example, “A or B”, “at least one of A and B” or “at least one of A or B” may mean (1) including at least one A, (2) including at least one B, (3) including either A or B, or (4) including both at least one A and at least one B.

Any step or act disclosed herein as being performed, or capable of being performed, by a computer or other machine, may be performed automatically by a computer or other machine, whether or not explicitly disclosed as such herein. A step or act that is performed automatically is performed solely by a computer or other machine, without human intervention. A step or act that is performed automatically may, for example, operate solely on inputs received from a computer or other machine, and not from a human. A step or act that is performed automatically may, for example, be initiated by a signal received from a computer or other machine, and not from a human. A step or act that is performed automatically may, for example, provide output to a computer or other machine, and not to a human.

The systems and methods described above may be implemented as a method, apparatus, or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be LISP, PROLOG, PERL, C, C++, C#, JAVA, Python, Rust, Go, or any compiled or interpreted programming language.

Each such computer program may be implemented in a computer program product tangibly embodied in a machine-readable storage device for execution by a computer processor. Method steps may be performed by a computer processor executing a program tangibly embodied on a computer-readable medium to perform functions of the methods and systems described herein by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip; electronic devices; a computer-readable non-volatile storage unit; non-volatile memory, such as semiconductor memory devices, including EPROM, EEPROM, and flash memory devices; magnetic disks such as internal hard disks and removable disks; magneto-optical disks; and CD-ROMs). Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data (including, for example, instructions for storage on non-transitory computer-readable media) from a second computer providing access to the programs via a network transmission line, wireless transmission media, signals propagating through space, radio waves, infrared signals, etc.

In some embodiments, the system 100 includes non-transitory, computer-readable medium comprising computer program instructions tangibly stored on the non-transitory computer-readable medium, wherein the instructions are executable by at least one processor to perform each of the steps described above in connection with FIGS. 2-5.

The systems and methods described above may be implemented as a method, apparatus, or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be LISP, PROLOG, PERL, C, C++, C#, JAVA, Python, Rust, Go, or any compiled or interpreted programming language.

Each such computer program may be implemented in a computer program product tangibly embodied in a machine-readable storage device for execution by a computer processor. Method steps may be performed by a computer processor executing a program tangibly embodied on a computer-readable medium to perform functions of the methods and systems described herein by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip; electronic devices; a computer-readable non-volatile storage unit; non-volatile memory, such as semiconductor memory devices, including EPROM, EEPROM, and flash memory devices; magnetic disks such as internal hard disks and removable disks; magneto-optical disks; and CD-ROMs). Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or grayscale pixels on paper, film, display screen, or other output medium. A computer may also receive programs and data (including, for example, instructions for storage on non-transitory computer-readable media) from a second computer providing access to the programs via a network transmission line, wireless transmission media, signals propagating through space, radio waves, infrared signals, etc.

Referring now to FIGS. 6A, 6B, and 6C, block diagrams depict additional detail regarding computing devices that may be modified to execute novel, non-obvious functionality for implementing the methods and systems described above.

Referring now to FIG. 6A, an embodiment of a network environment is depicted. In brief overview, the network environment comprises one or more clients 602a-602n (also generally referred to as local machine(s) 602, client(s) 602, client node(s) 602, client machine(s) 602, client computer(s) 602, client device(s) 602, computing device(s) 602, endpoint(s) 602, or endpoint node(s) 602) in communication with one or more remote machines 606a-606n (also generally referred to as server(s) 606 or computing device(s) 606) via one or more networks 404.

Although FIG. 6A shows a network 604 between the clients 602 and the remote machines 606, the clients 602 and the remote machines 606 may be on the same network 604. The network 604 can be a local area network (LAN), such as a company Intranet, a metropolitan area network (MAN), or a wide area network (WAN), such as the Internet or the World Wide Web. In some embodiments, there are multiple networks 604 between the clients 602 and the remote machines 606. In one of these embodiments, a network 604′ (not shown) may be a private network and a network 604 may be a public network. In another of these embodiments, a network 604 may be a private network and a network 604′ a public network. In still another embodiment, networks 604 and 604′ may both be private networks. In yet another embodiment, networks 604 and 604′ may both be public networks.

The network 604 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, an SDH (Synchronous Digital Hierarchy) network, a wireless network, a wireline network, an Ethernet, a virtual private network (VPN), a software-defined network (SDN), a network within the cloud such as AWS VPC (Virtual Private Cloud) network or Azure Virtual Network (VNet), and a RDMA (Remote Direct Memory Access) network. In some embodiments, the network 404 may comprise a wireless link, such as an infrared channel or satellite band. The topology of the network 604 may be a bus, star, or ring network topology. The network 604 may be of any such network topology as known to those ordinarily skilled in the art capable of supporting the operations described herein. The network may comprise mobile telephone networks utilizing any protocol or protocols used to communicate among mobile devices (including tables and handheld devices generally), including AMPS, TDMA, CDMA, GSM, GPRS, UMTS, or LTE. In some embodiments, different types of data may be transmitted via different protocols. In other embodiments, the same types of data may be transmitted via different protocols.

A client 602 and a remote machine 606 (referred to generally as computing devices 600, devices 600, or as machines 600) can be any workstation, desktop computer, laptop or notebook computer, server, portable computer, mobile telephone, mobile smartphone, or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A client 602 may execute, operate or otherwise provide an application, which can be any type and/or form of software, program, or executable instructions, including, without limitation, any type and/or form of web browser, web-based client, client-server application, an ActiveX control, a JAVA applet, a webserver, a database, an HPC (high performance computing) application, a data processing application, or any other type and/or form of executable instructions capable of executing on client 602.

In one embodiment, a computing device 606 provides functionality of a web server. The web server may be any type of web server, including web servers that are open-source web servers, web servers that execute proprietary software, and cloud-based web servers where a third party hosts the hardware executing the functionality of the web server. In some embodiments, a web server 606 comprises an open-source web server, such as the APACHE servers maintained by the Apache Software Foundation of Delaware. In other embodiments, the web server executes proprietary software, such as the INTERNET INFORMATION SERVICES products provided by Microsoft Corporation of Redmond, WA, the ORACLE IPLANET web server products provided by Oracle Corporation of Redwood Shores, CA, or the ORACLE WEBLOGIC products provided by Oracle Corporation of Redwood Shores, CA.

In some embodiments, the system may include multiple, logically-grouped remote machines 606. In one of these embodiments, the logical group of remote machines may be referred to as a server farm 638. In another of these embodiments, the server farm 638 may be administered as a single entity.

FIGS. 6B and 6C depict block diagrams of a computing device 600 useful for practicing an embodiment of the client 602 or a remote machine 606. As shown in FIGS. 6B and 6C, each computing device 600 includes a central processing unit 621, and a main memory unit 622. As shown in FIG. 6B, a computing device 600 may include a storage device 628, an installation device 616, a network interface 618, an I/O controller 623, display devices 624a-n, a keyboard 626, a pointing device 627, such as a mouse, and one or more other I/O devices 630a-n. The storage device 628 may include, without limitation, an operating system and software. As shown in FIG. 6C, each computing device 600 may also include additional optional elements, such as a memory port 603, a bridge 670, one or more input/output devices 630a-n (generally referred to using reference numeral 630), and a cache memory 640 in communication with the central processing unit 621.

The central processing unit 621 is any logic circuitry that responds to and processes instructions fetched from the main memory unit 622. In many embodiments, the central processing unit 621 is provided by a microprocessor unit, such as: those manufactured by Intel Corporation of Mountain View, CA; those manufactured by Motorola Corporation of Schaumburg, IL; those manufactured by Transmeta Corporation of Santa Clara, CA; those manufactured by International Business Machines of White Plains, NY; or those manufactured by Advanced Micro Devices of Sunnyvale, CA. Other examples include RISC-V processors, SPARC processors, ARM processors, processors used to build UNIX/LINUX “white” boxes, and processors for mobile devices. The computing device 600 may be based on any of these processors, or any other processor capable of operating as described herein.

Main memory unit 622 may be one or more memory chips capable of storing data and allowing any storage location to be directly accessed by the microprocessor 621. The main memory 622 may be based on any available memory chips capable of operating as described herein. In the embodiment shown in FIG. 6B, the processor 621 communicates with main memory 622 via a system bus 650. FIG. 6C depicts an embodiment of a computing device 600 in which the processor communicates directly with main memory 622 via a memory port 603. FIG. 6C also depicts an embodiment in which the main processor 621 communicates directly with cache memory 640 via a secondary bus, sometimes referred to as a backside bus. In other embodiments, the main processor 621 communicates with cache memory 640 using the system bus 650.

In the embodiment shown in FIG. 6B, the processor 621 communicates with various I/O devices 630 via a local system bus 650. Various buses may be used to connect the central processing unit 621 to any of the I/O devices 630, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 624, the processor 621 may use an Advanced Graphics Port (AGP) to communicate with the display 624. FIG. 6C depicts an embodiment of a computing device 600 in which the main processor 621 also communicates directly with an I/O device 630b via, for example, HYPERTRANSPORT, RAPIDIO, or INFINIBAND communications technology.

One or more of a wide variety of I/O devices 630a-n may be present in or connected to the computing device 600, each of which may be of the same or different type and/or form. Input devices include keyboards, mice, trackpads, trackballs, microphones, scanners, cameras, and drawing tablets. Output devices include video displays, speakers, inkjet printers, laser printers, 3D printers, and dye-sublimation printers. The I/O devices may be controlled by an I/O controller 623 as shown in FIG. 6B. Furthermore, an I/O device may also provide storage and/or an installation medium 616 for the computing device 600. In some embodiments, the computing device 600 may provide USB connections (not shown) to receive handheld USB storage devices such as the USB Flash Drive line of devices manufactured by Twintech Industry, Inc. of Los Alamitos, CA.

Referring still to FIG. 6B, the computing device 600 may support any suitable installation device 616, such as hardware for receiving and interacting with removable storage; e.g., disk drives of any type, CD drives of any type, DVD drives, tape drives of various formats, USB devices, external hard drives, or any other device suitable for installing software and programs. In some embodiments, the computing device 600 may provide functionality for installing software over a network 604. The computing device 600 may further comprise a storage device, such as one or more hard disk drives or redundant arrays of independent disks, for storing an operating system and other software. Alternatively, the computing device 600 may rely on memory chips for storage instead of hard disks.

Furthermore, the computing device 600 may include a network interface 618 to interface to the network 604 through a variety of connections including, but not limited to, standard telephone lines, LAN or WAN links (e.g., 802.11, T1, T3, 56kb, X.25, SNA, DECNET, RDMA), broadband connections (e.g., ISDN, Frame Relay, ATM, Gigabit Ethernet, Ethernet-over-SONET), wireless connections, virtual private network (VPN) connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, 802.15.4, Bluetooth, ZIGBEE, CDMA, GSM, WiMax, and direct asynchronous connections). In one embodiment, the computing device 600 communicates with other computing devices 600′ via any type and/or form of gateway or tunneling protocol such as GRE, VXLAN, IPIP, SIT, ip6tnl, VTI and VTI6, IP6GRE, FOU, GUE, GENEVE, ERSPAN, Secure Socket Layer (SSL) or Transport Layer Security (TLS). The network interface 618 may comprise a built-in network adapter, network interface card, PCMCIA network card, card bus network adapter, wireless network adapter, USB network adapter, modem, or any other device suitable for interfacing the computing device 600 to any type of network capable of communication and performing the operations described herein.

In further embodiments, an I/O device 630 may be a bridge between the system bus 650 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 600 of the sort depicted in FIGS. 6B and 6C typically operates under the control of operating systems, which control scheduling of tasks and access to system resources. The computing device 600 can be running any operating system such as any of the versions of the MICROSOFT WINDOWS operating systems, the different releases of the UNIX and LINUX operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 7, WINDOWS 8, WINDOWS VISTA, WINDOWS 10, and WINDOWS 11 all of which are manufactured by Microsoft Corporation of Redmond, WA; MAC OS manufactured by Apple Inc. of Cupertino, CA; OS/2 manufactured by International Business Machines of Armonk, NY; Red Hat Enterprise Linux, a Linux-variant operating system distributed by Red Hat, Inc., of Raleigh, NC; Ubuntu, a freely-available operating system distributed by Canonical Ltd. of London, England; CentOS, a freely-available operating system distributed by the centos.org community; SUSE Linux, a freely-available operating system distributed by SUSE, or any type and/or form of a Unix operating system, among others.

Having described certain embodiments of methods and systems for methods and systems for transporting a user from a first virtual environment to a second virtual environment in a plurality of virtual environments while maintaining access to a digital wallet of the user, it will be apparent to one of skill in the art that other embodiments incorporating the concepts of the disclosure may be used. Therefore, the disclosure should not be limited to certain embodiments, but rather should be limited only by the spirit and scope of the following claims.

What is claimed is:

1. A method for transferring control over at least one session associated with a user from a first virtual environment in a plurality of virtual environments to a second virtual environment in the plurality of virtual environments, the method comprising:
receiving, by a first virtual environment executing on a first computing device, from a user, a request for a transfer to a second virtual environment, wherein the first virtual environment is associated with a first entity, and wherein the second virtual environment is associated with a second entity;
transmitting, by the first virtual environment to a first event handler executing on the first computing device, the request;
retrieving, by the first event handler, an address for the second virtual environment and an identification of a location within the second virtual environment at which to instantiate at least one digital resource associated with the user;
establishing, by the first event handler, an Application Programming Interface (API) connection to a second computing device executing a second event handler; and
transmitting, by the first event handler, to the second event handler, via the API connection, (i) an identification of the user and (ii) an instruction to establish a session between the user and the second virtual environment.

2. The method of claim 1 further comprising:
receiving, by the second event handler, from the second virtual environment, a request for access to a digital asset associated with the user and used within the first virtual environment;
requesting, by the second event handler, from a digital wallet of the user, access to the digital asset; and
receiving, by the second event handler, from the digital wallet, an instruction for accessing a location of the digital asset on a block chain;
providing, by the second event handler, to the second virtual environment, access to the digital asset.

3. The method of claim 1 further comprising, before receiving the request for the transfer, receiving a request for an enumeration of the plurality of virtual environments.

4. The method of claim 1 further comprising, before receiving the request for the transfer, an indication that a digital representation of the user is rendered at a location in the first virtual environment from which users may request transfers out of the first virtual environment.

5. A method for converting, from within one of a plurality of virtual environments, by a digital wallet, one of a plurality of cryptocurrencies into a second of the plurality of cryptocurrencies, the second of the plurality of cryptocurrencies used within the one of the plurality of virtual environments, the method comprising:
receiving, by a component, a request for access to a first type of token of a first cryptocurrency used by a first virtual environment;
determining, by the component, that the digital wallet has access to a second type of token a second cryptocurrency used by a second virtual environment;
identifying, by the component, a type of smart contract to execute to implement an exchange of cryptocurrency, wherein identifying further comprises analyzing data within the received request;
generating, by the component, a smart contract request for an exchange of cryptocurrency in compliance with the identified type of smart contract;
executing, by the component, the smart contract request;
receiving, by the component, an indication that the digital wallet has access to the second type of token of the second cryptocurrency; and
updating, by the component, a user interface element displaying, to a user of the digital wallet, an account balance of the second type of token of the second cryptocurrency available via the digital wallet.

6. The method of claim 5, wherein determining further comprises determining that the first type of token is the same type as the second type of token and determining that the first cryptocurrency uses a different blockchain than the second cryptocurrency.

7. The method of claim 5, wherein determining further comprises determining that the first type of token is a different type as the second type of token and determining that the first cryptocurrency uses a different blockchain than the second cryptocurrency.

8. The method of claim 5, wherein determining further comprises determining that the first type of token is the same type as the second type of token and determining that the first cryptocurrency uses the same blockchain as the second cryptocurrency.

9. The method of claim 5, wherein determining further comprises determining that the first type of token is a different type as the second type of token and determining that the first cryptocurrency uses the same blockchain than the second cryptocurrency.

10. The method of claim 5, wherein identifying the type of smart contract further comprises identifying a type of swap contract.

11. A method for transferring control over at least one session associated with a user from a first virtual environment in a plurality of virtual environments to a second virtual environment in the plurality of virtual environments, the method comprising:
receiving, by a first virtual environment executing on a first computing device, from a user, a request for a transfer to a second virtual environment, wherein the first virtual environment is associated with a first entity and the second virtual environment is associated with a second entity;
transmitting, by the first virtual environment to a first event handler executing on the first computing device, the request;
retrieving, by the first event handler, an address for the second virtual environment and an identification of a location within the second virtual environment at which to instantiate at least one digital resource associated with the user;
establishing, by the first event handler, an Application Programming Interface (API) connection to a second computing device executing a second event handler;
transmitting, by the first event handler, to the second event handler, via the API connection, (i) an identification of the user and (ii) an instruction to establish a session between the user and the second virtual environment;
receiving, by a component, executed by the second event handler, a request for access to a first type of token in a first cryptocurrency used by the second virtual environment;
determining, by the component, that a digital wallet of the user has access to a second type of token of a second cryptocurrency used by the first virtual environment;
identifying, by the component a type of smart contract to execute to implement an exchange of cryptocurrency, wherein identifying further comprises analyzing data within the received request;
generating, by the component, a smart contract request for an exchange of cryptocurrency in compliance with the identified type of smart contract;
executing, by the component, the smart contract request;
receiving, by the component, an indication that the digital wallet has access to the first type of token in the first cryptocurrency; and
updating, by the component, a user interface element displaying, to the user of the digital wallet, an account balance of the first type of token of the first cryptocurrency available via the digital wallet.
